(19) United States
(12) Patent Application Publication
(10) Pub. No.: US 2013/0342477 A1
(43) Pub. Date: Dec. 26, 2013

(54) SENSOR FOR DIGITIZER AND METHOD FOR MANUFACTURING THE SAME

(71) Applicants: Dong Sik Yoo, Gyunggi-do (KR); Kyoung Soo Chae, Gyunggi-do (KR); Hee Bum Lee, Gyunggi-do (KR); Ho Yun Cho, Gyunggi-do (KR); Yun Ki Hong, Gyunggi-do (KR)

(72) Inventors: Dong Sik Yoo, Gyunggi-do (KR); Kyoung Soo Chae, Gyunggi-do (KR); Hee Bum Lee, Gyunggi-do (KR); Ho Yun Cho, Gyunggi-do (KR); Yun Ki Hong, Gyunggi-do (KR)

(73) Assignee: SAMSUNG ELECTRO-MECHANICS CO., LTD., Gyunggi-do (KR)

(21) Appl. No.: 13/592,080

(22) Filed: Aug. 22, 2012

(30) Foreign Application Priority Data
Jun. 22, 2012 (KR) 10-2012-0067439

(51) Int. Cl. G06F 3/041; H01F 41/00

(52) U.S. Cl. 345/173; 29/602.1; 178/18.03

(57) ABSTRACT

Disclosed herein is a sensor for a digitizer including a first magnetic layer, a first coil formed on one surface of the first magnetic layer, an insulating layer formed on one surface of the first magnetic layer, a second coil formed on one surface the insulating layer, and a second magnetic layer formed on one surface of the insulating layer, and a method for manufacturing the same.

### CROSS REFERENCE TO RELATED APPLICATION

This application claims the benefit of Korean Patent Application No. 10-2012-0067439, filed on Jun. 22, 2012, entitled “Sensor for Digitizer and Method for Manufacturing the Same”, which is hereby incorporated by reference in its entirety into this application.

### BACKGROUND OF THE INVENTION

1. Technical Field

The present invention relates to a sensor for a digitizer and a method for manufacturing the same.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

In accordance with the rapid advancement of an information-oriented society, the use of computers has gradually increased. However, it is difficult to efficiently operate products only using a keyboard and mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, an electromagnetic induction type digitizer has been developed as an input device capable of inputting information such as text, graphics, or the like.

A capacitive type touch screen is present as the input device capable of performing functions similar to those of the electromagnetic induction type digitizer. However, the capacitive type touch screen cannot sense an accurate coordinate as compared to the electromagnetic induction type digitizer and cannot recognize writing pressure, either. Therefore, the electromagnetic induction type digitizer is more advantageous than the capacitive type touch screen in view of precision and accuracy.

An example of the digitizer according to the prior art is disclosed in Korean Patent No. 10-0510729, as the prior art.

The digitizer disclosed in Korean Patent No. 10-0510729 is configured to include a sensor that is disposed on a lower portion of a liquid crystal panel and recognizes a touch location of an electronic pen by transmitting and receiving an electric wave which is resonated at a location touched by the electronic pen, and a controller controlling the sensor.

In this configuration, the sensor is configured of a sensor PCB, and a plurality of x-axis coils and y-axis coils formed on the sensor PCB.

In addition, the controller is configured of a control processor unit (CPU) that is configured on the lower portion of the sensor and serves to sense the location of the electronic pen by transmitting a signal to the sensor and reading again a signal to be input.

In addition, the electronic pen includes a resonant circuit embedded therein, the resonant circuit including a coil and a condenser.

The digitizer according to the prior art is operated by receiving, in the sensor, the signal from the controller, and selects the x-axis coil and the y-axis coil to generate the electric wave while inducing an electromagnetism. The electronic pen is resonated by the generated electric wave, and a resonant frequency is received by the sensor while being held for a predetermined time. The controller senses the touch location by reading the signal that is received by the sensor.

Meanwhile, the digitizer is required to further improve stability of the signal, that is, the transmitted and/or received signals from and/or to the coil does need not to be attenuated due to an effect of peripheral devices. However, the digitizer according to the prior art as described above does not include a separate configuration for satisfying the requirement as described above.

### SUMMARY OF THE INVENTION

The present invention has been made in an effort to provide a sensor for a digitizer capable of improving stability of signal transmitted and/or received from and/or to the sensor, and a method for manufacturing the same.

According to a preferred embodiment of the present invention, there is provided a sensor for a digitizer, including: a first magnetic layer; a first coil formed on one surface of the first magnetic layer; an insulating layer formed on one surface of the first magnetic layer; a second coil formed on one surface of the insulating layer; and a second magnetic layer formed on one surface of the insulating layer.

The sensor for a digitizer may further include a power coil formed on one surface of the second magnetic layer.

The power coil may be formed on an outer region of the second magnetic layer so as not to intersect with the first coil and the second coil in a vertical direction.

Any one or both of the first magnetic layer and the second magnetic layer may be made of an oxide magnetic material including two or more elements selected from a group consisting of Fe, Ni, Zn, Mn, Mg, Co, Ba and Sr.

The first coil may be formed to have a length direction in a first axis direction, and the second coil may be formed to have a length direction in a second axis direction that is perpendicular to the first axis direction.

The first coil may be formed in plural so as to be arranged in the second axis direction, and the second coil may be formed in plural so as to be arranged in the first axis direction.

The first coil may be buried in the other surface of the insulating layer.

The second coil may be buried in the other surface of the second magnetic layer.

According to a second preferred embodiment of the present invention, there is provided a method for manufacturing a sensor for a digitizer, including: forming a first magnetic layer on one surface of a base film; forming a first coil on one surface of the first magnetic layer; forming an insulating layer on one surface of the first magnetic layer so as to cover the first coil; forming a second coil on one surface of the insulating layer; and forming a second magnetic layer on one surface of the insulating layer so as to cover the second coil.

The method may further include, after the forming of the first magnetic layer, delaminating the base film from the first magnetic layer.

The method may further include, after the forming of the second magnetic layer, forming a power coil on one surface of the second magnetic layer.

The power coil may be formed on an outer region of the second magnetic layer so as not to intersect with the first coil and the second coil in a vertical direction.

Any one or both of the first magnetic layer and the second magnetic layer are made of an oxide magnetic material including two or more elements selected from a group consisting of Fe, Ni, Zn, Mn, Mg, Co, Ba and Sr.

The first coil may be formed to have a length direction in a first axis direction, and the second coil may be formed to have a length direction in a second axis direction that is perpendicular to the first axis direction.

The first coil may be formed in plural so as to be arranged in the second axis direction, and the second coil may be formed in plural so as to be arranged in the first axis direction.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a sensor for a digitizer according to a first preferred embodiment of the present invention;

FIG. 2 is a perspective view of a main configuration capable of appreciating shapes of the first coil and the second coil shown in FIG. 1;

FIGS. 3 to 7 are cross-sectional views describing a method for manufacturing the sensor for a digitizer shown in FIG. 1; and

FIG. 8 is a cross-sectional view of a sensor for a digitizer according to a second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, a sensor for a digitizer and a method for manufacturing the same according to a first preferred embodiment of the present invention will be described in detail with reference to the accompanying drawings.

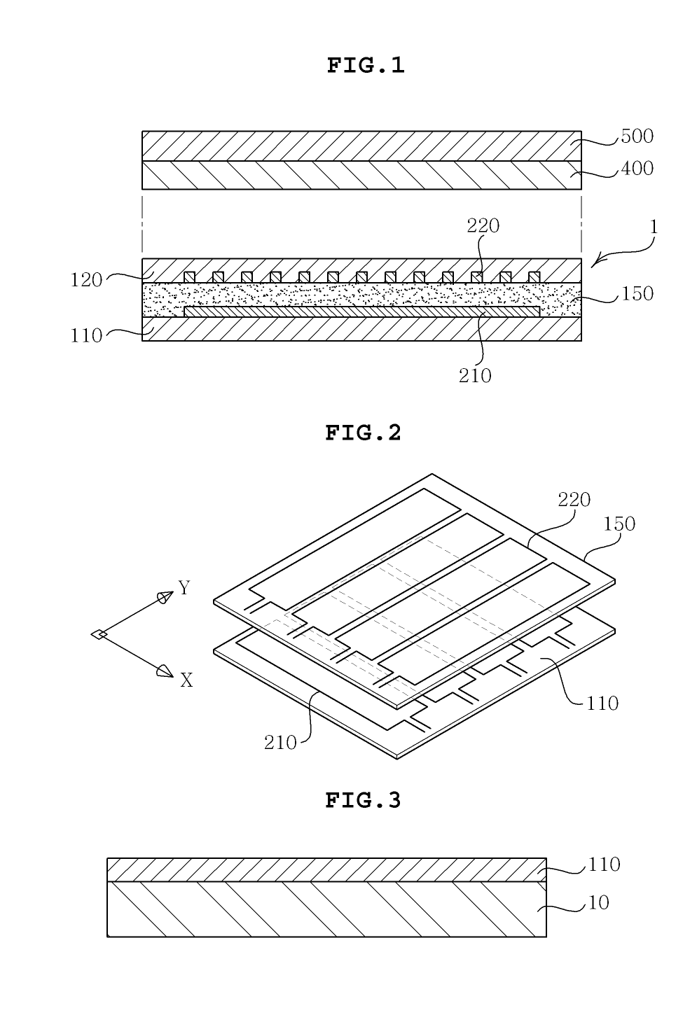

FIG. 1 is a cross-sectional view of a sensor for a digitizer according to a first preferred embodiment of the present invention. FIG. 2 is a perspective view of a main configuration capable of appreciating shapes of a first coil and a second coil shown in FIG. 1. FIGS. 3 to 7 are cross-sectional views describing a method for manufacturing the sensor for a digitizer shown in FIG. 1.

As shown in FIG. 1, the sensor 1 for a digitizer according to the first preferred embodiment includes a first magnetic layer 110, a first coil 210 formed on one surface of the first magnetic layer 110, an insulating layer 150 formed on one surface of the first magnetic layer 110, a second coil 220 formed on one surface of the insulating layer 150, and a second magnetic layer 120 formed on one surface of the insulating layer 150.

The first magnetic layer 110 is made of magnetic material, similar to the second magnetic layer 120 to be described below, and serves to improve stability of signal transmitted/received between a resonant circuit and a coil of an input device (not shown) such as an electronic pen. In addition, the first magnetic layer 110 may have an electric insulation so as to insulate between the first coils 210 to be described below.

Specifically, the first magnetic layer 110 may be made of magnetic material having high permeability. As a specific example, the first magnetic layer 110 may be made of an oxide magnetic material including two or more elements selected from a group consisting of Fe, Ni, Zn, Mn, Mg, Co, Ba and Sr. The first magnetic layer 110 is made of the materials as mentioned above, thereby having the electric insulation due to high specific resistance.

The first coil 210 is formed on one surface of the first magnetic layer 110. In this configuration, the first coil 210 may be formed in a loop shape having a length direction in a first axis direction, for example, in an x-axis direction as shown in FIG. 2. In addition, a plurality of first coils 210 may be connected to each other in parallel while being arranged in a second axis direction, for example, in a y-axis direction as shown in FIG. 2.

The insulating layer 150 serves to electrically insulate between the first coil 210 and the second coil 220. In addition, the insulating layer 150 serves to insulate between adjacent lines of the first coils 210 to be described below. Therefore, the insulating layer 150 has electric insulation. The insulating layer 150 may be made of various insulating materials such as polyethylene terephthalate (PET), polycarbonate (PC), poly methyl methacrylate (PMMA), polyethylene naphthalate (PEN), polyethersulfone (PES), or the like, for example.

The insulating layer 150 is formed on one surface of the first magnetic layer 110. In this configuration, the insulating layer 150 may be formed to cover the first coil 210. In this case, the first coil 210 is buried in the other surface of the insulating layer 150, as shown in FIG. 1. In the case in which the first coil 210 is buried in the other surface of the insulating layer 150, the first coil 210 may be perfectly buried in the first magnetic layer 110 and the insulating layer 150, thereby sufficiently insulating between the adjacent lines of the first coils 210.

The second coil 220 is formed on one surface of the insulating layer 150. In this configuration, the second coil 220 may be formed in a loop shape having a length direction in a direction in which it intersects with the first coil 210 in a vertical direction, as shown in FIG. 2. In this configuration, the second coil 220 may have the length direction in the second axis direction that is perpendicular to the first axis direction, that is, in the y-axis direction in order to perpendicularly intersect with the first coil 210. In addition, a plurality of second coils 220 may be connected to each other in parallel while being arranged in the x-axis direction.

The second magnetic layer 120 may be made of magnetic material, similar to the first magnetic layer 110, thereby improving stability of the signal transmitted/received between the resonant circuit and the coil of the input device. In addition, the second magnetic layer 120 may have the electric insulation so as to insulate between the second coils 220. Similar to the first coil 210, as an example, the second magnetic layer 120 may be made of an oxide magnetic material including two or more elements selected from a group consisting of Fe, Ni, Zn, Mn, Mg, Co, Ba and Sr. The second magnetic layer 120 is made of the materials as mentioned above, thereby having the electric insulation due to high specific resistance.

The second layer 120 is formed on one surface of the insulating layer 150. In this configuration, the second magnetic layer 120 may be formed so as to cover the second coil 220. In this case, the second coil 220 is buried in the other surface of the second magnetic layer 120. Therefore, the second coil 220 may be perfectly buried in the insulating layer 150 and the second magnetic layer 120, thereby sufficiently insulating between the adjacent lines of the second coils 220.

Meanwhile, the first coil 210 and the second coil 220 as described above are configured for sensing the touch location of the input device.

First, the resonant circuit including inductor and capacitor may be embedded within the input device (not shown) such as the electronic pen. The input device as described above allows the resonant circuit to be resonated by an electromagnetic force input from the outside. The resonant circuit generates an induced current while being resonated. Then, energy by the generated induced current may be stored in the capacitor.

In addition, when the electromagnetic force is not supplied from the outside, the input device allows the capacitor to be resonated with the inductor by the energy stored in the capacitor, thereby emitting the electromagnetic force during this process.

The electromagnetic force emitted from the input device generates a voltage difference between the first coil 210 and the second coil 220, and the controller (not shown) confirms the voltage difference to thereby detect the touch location of the input device.

Here, any one of the first coil 210 and the second coil 220 may be used as a driving coil that is supplied with the current from the controller. In addition, the other coil may be used as a sensing coil in which the voltage is generated by a magnetic force line induced from the driving coil. The voltage (an induced electromotive force) induced from the sensing coil is in proportion to a change amount of magnetic force line induced from the driving coil according to time. Therefore, in order to induce the voltage from the sensing coil, the magnetic force line induced from the driving coil needs to be periodically changed. As a result, the driving coil is supplied with alternating current (AC) from the controller in order to periodically change the magnetic force line induced from the driving coil.

The first coil 210 and the second coil 220 have the voltage while being controlled by the controller. In this case, when the input device approaches the coils, the coils generate the voltage difference by an effect of the electromagnetic force emitted from the input device as described above. Therefore, the controller senses the voltage difference to confirm the touch location of the input device.

The sensor 1 for the digitizer formed as described above may be coupled to an image display device 400 and a window 500 that are disposed in one side direction as shown in FIG. 1.

Hereinafter, a method for manufacturing a sensor for a digitizer according to a preferred embodiment of the present invention will be described. However, contents already described in the description with respect to the first preferred embodiment will be omitted.

As shown in FIGS. 3 to 7, the method for manufacturing the sensor for a digitizer according to the preferred embodiment of the present invention includes (a) forming a first magnetic layer 110 on one surface of a base film 10, (b) forming a first coil 210 on one surface of the first magnetic layer 110, (c) forming an insulating layer 150 on one surface of the first magnetic layer 110 to cover the first coil 210, (d) forming a second coil 220 on one surface of the insulating layer 150, and (e) forming a second magnetic layer 120 on one surface of the insulating layer 150 so as to cover the second coil 220.

In step (a), the first magnetic layer 110 is formed on one surface of the base film 10, as shown in FIG. 3. As an example of the base film 10, a PET film, or the like, may be used. In addition, the first magnetic layer 110 may be made of an oxide magnetic material including two or more elements selected from a group consisting of Fe, Ni, Zn, Mn, Mg, Co, Ba and Sr.

For example, the first magnetic layer 110 may be formed on one surface of the base film 10 by mixing powder and polymer binder that are material of the first magnetic layer 110 each other, applying the mixed power and polymer binder onto the base film 10, and thermally pressing the base film using a method such as a rolling or casting method. However, as the method of forming the first magnetic layer 110 on the base film 10, various known methods other than the method as described above may be used.

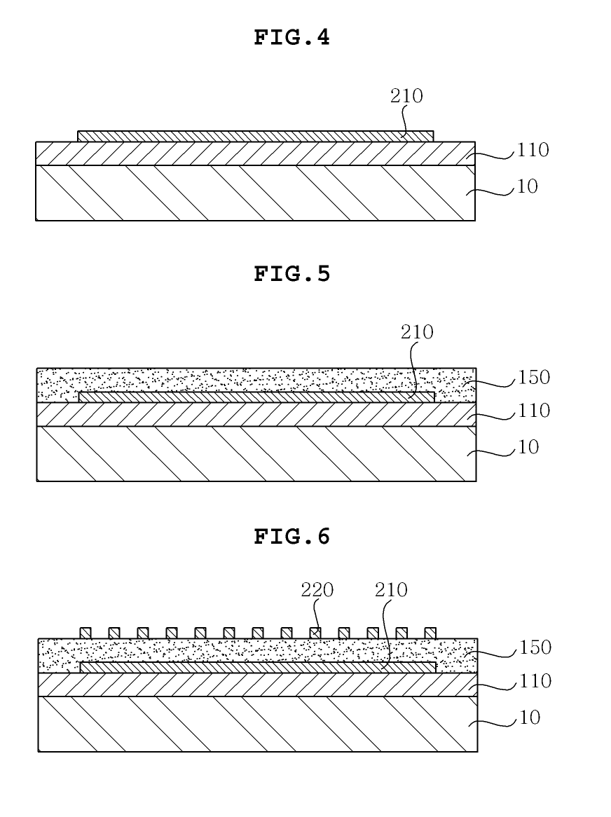

In step (b), the first coil 210 is formed on one surface of the first magnetic layer 110, as shown in FIG. 4. The first coil 210 may be formed on one surface of the first magnetic layer 110 by various methods such as a plating method or an evaporation method. Further, the first coil 210 may be formed in a loop shape. In addition, a plurality of first coils 210 may be arranged in parallel with each other so as to have a construction in which they are connected in parallel with each other.

In step (c), the insulating layer 150 is formed on one surface of the magnetic layer 110, as shown in FIG. 5.

The insulating layer 150 may be made of various materials having insulation such as a PET, or the like. The insulating layer 150 is applied onto one surface of the first magnetic layer 110 so as to cover the first coil 210. Therefore, the first coil 210 may be perfectly buried in the insulating layer 150 and the first magnetic layer 110, thereby sufficiently insulating between the adjacent lines of the first coils 210.

In step (d), the second coil 220 is formed on one surface of the insulating layer 150, as shown in FIG. 6.

The second coil 220 may be formed on the insulating layer 150 by various methods such as a plating method or an evaporation method, similar to the first coil 210. The second coil 220 may be formed in a loop form similar to that of the first coil 210. In this configuration, the second coil 220 may be formed to have a length direction in a direction in which it intersects with the first coil 210. Further, a plurality of second coils 220 may be arranged in parallel with each other so as to have a construction in which they are connected in parallel with each other.

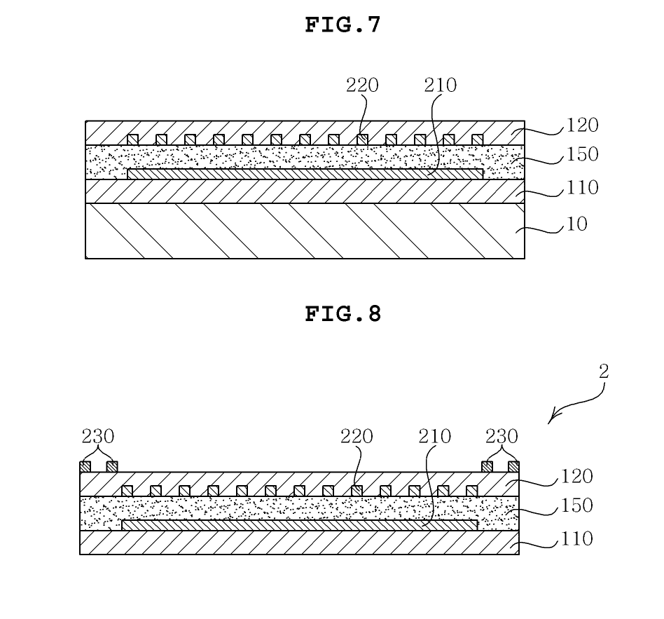

In step (e), the second magnetic layer 120 is formed on one surface of the insulating layer 150, as shown in FIG. 7.

The second magnetic layer 120 may be made of the same materials as that of the first magnet layer 110 and be formed by the same method as that of the first magnetic layer 110. Here, the second magnetic layer 120 is formed on one surface of the insulating layer 150 so as to cover the second coil 220. Therefore, the second coil 220 may be perfectly buried in the insulating layer 150 and the second magnetic layer 120, thereby sufficiently insulating between the adjacent lines of the second coils 220.

Meanwhile, the base film 10 that is prepared in step (a) may be removed by delamination after step (a). FIG. 1 shows a state in which the base film 10 is removed. The base film 10 may be delaminated immediately after step (a) or be delaminated after any one of steps (b) to (e).

Hereinafter, a sensor 2 for a digitizer according to a second preferred embodiment of the present invention will be described in detail with reference to the accompanying drawings. However, the same components as those of the first preferred embodiment will be denoted by the same reference numerals in the accompanying drawings, and a detailed description thereof will be omitted.

FIG. 8 is a cross-sectional view of a sensor 2 for the digitizer according to a second preferred embodiment of the present invention.

As shown in FIG. 8, the sensor 2 for the digitizer according to the second preferred embodiment of the present invention is different from the sensor 1 for the digitizer according to the first preferred embodiment of the present invention in that it further includes separate power coils 230.

First, the input device may be configured of a powerless input device that is resonated by receiving the electromagnetic force from the outside as described above or may have a construction in which the resonant circuit of the input device receives alternating current power from the outside to resonate.

When the input device is operated by receiving the alternating current power from the outside, the sensor for a digitizer needs not to further include the separate power coils.

However, in the case in which the input device is the powerless input device as described above, that is, in the case in which the input device receives the electromagnetic force from the sensor for a digitizer, the sensor for a digitizer needs to include the separate power coils.

In the sensor for a digitizer, any one of the first coil 210 and the second coil 220 may serve as the power coils. However, the sensor for a digitizer may further include the separate power coils which are separately controlled by the controller, thereby further increasing reliability in transmission and reception of the signal between the input device and the coil.

The sensor 2 for a digitizer according to the second preferred embodiment of the invention is configured to further include the power coils 230, in addition to the components of the sensor 1 for a digitizer according to the first preferred embodiment of the present invention. In this configuration, the power coils 230 may also be formed together with the second coil 220 on one surface of the insulating layer 150. However, it is desirable for the power coil 230 to be formed on a location closer to the input device in order to more stably supply the power to the input device. Therefore, the power coil 230 may be formed on one surface of the second magnetic layer 120.

In addition, it is desirable for the power coil 230 to be formed so as not to overlap with the region in which the touch location is sensed. Therefore, the power coils 230 may be formed on an outer region of the second magnetic layer 120 in which the power coils 230 do not intersect with the first coil 210 and the second coil 220 in a vertical direction. In addition, the power coils 230 may have a loop shape in which they are formed along the outer region of the second magnetic layer 120.

As set forth above, according to the present invention as describe above, the first coil 210 and the second coil 220 are disposed within the first magnetic layer 110 and the second layer 120 that are made of the magnetic material, thereby forming magnetic fields between the coils or improving stability of the signal transmitted/received between the coil and the input device.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A sensor for a digitizer, comprising:
a first magnetic layer;
a first coil formed on one surface of the first magnetic layer;
an insulating layer formed on one surface of the first magnetic layer;
a second coil formed on one surface of the insulating layer; and
a second magnetic layer formed on one surface of the insulating layer.

2. The sensor for a digitizer as set forth in claim 1, further comprising:
a power coil formed on one surface of the second magnetic layer.

3. The sensor for a digitizer as set forth in claim 2, wherein the power coil is formed on an outer region of the second magnetic layer so as not to intersect with the first coil and the second coil in a vertical direction.

4. The sensor for a digitizer as set forth in claim 1, wherein any one or both of the first magnetic layer and the second magnetic layer are made of an oxide magnetic material including two or more elements selected from a group consisting of Fe, Ni, Zn, Mn, Mg, Co, Ba and Sr.

5. The sensor for a digitizer as set forth in claim 1, wherein the first coil is formed to have a length direction in a first axis direction, and the second coil is formed to have a length direction in a second axis direction that is perpendicular to the first axis direction.

6. The sensor for a digitizer as set forth in claim 5,
wherein the first coil is formed in plural so as to be arranged in the second axis direction, and
the second coil is formed in plural so as to be arranged in the first axis direction.

7. The sensor for a digitizer as set forth in claim 1, wherein the first coil is buried in the other surface of the insulating layer.

8. The sensor for a digitizer as set forth in claim 1, wherein the second coil is buried in the other surface of the second magnetic layer.

9. A method for manufacturing a sensor for a digitizer, comprising:
forming a first magnetic layer on one surface of a base film;
forming a first coil on one surface of the first magnetic layer;
forming an insulating layer on one surface of the first magnetic layer so as to cover the first coil;
forming a second coil on one surface of the insulating layer; and
forming a second magnetic layer on one surface of the insulating layer so as to cover the second coil.

10. The method as set forth in claim 9, further comprising:
after the forming of the first magnetic layer, delaminating the base film from the first magnetic layer.

11. The method as set forth in claim 9, further comprising:
after the forming of the second magnetic layer, forming a power coil on one surface of the second magnetic layer.

12. The method as set forth in claim 11, wherein the power coil is formed on an outer region of the second magnetic layer so as not to intersect with the first coil and the second coil in a vertical direction.

13. The method as set forth in claim 9, wherein any one or both of the first magnetic layer and the second magnetic layer are made of an oxide magnetic material including two or more elements selected from a group consisting of Fe, Ni, Zn, Mn, Mg, Co, Ba and Sr.

14. The method as set forth in claim 9, wherein the first coil is formed to have a length direction in a first axis direction, and the second coil is formed to have a length direction in a second axis direction that is perpendicular to the first axis direction.

15. The method as set forth in claim 14, wherein the first coil is formed in plural so as to be arranged in the second axis direction, and
the second coil is formed in plural so as to be arranged in the first axis direction.
